(19) United States
(12) Patent Application Publication
(10) Pub. No.: US 2005/0088957 A1
(43) Pub. Date: Apr. 28, 2005

(54) Cover sheet of substrate for data storage and method for preparing the same

(75) Inventors: Mi Young Han, Daejeon-city (KR); Tae Sik Kang, Daejeon-city (KR); Seongkeun Lee, Jeonju-city (KR); Sung Hoon Jang, Daejeon-city (KR); Yeongrae Chang, Daejeon-city (KR)

Correspondence Address: BIRCH STEWART KOLASCH & BIRCH, PO BOX 747, FALLS CHURCH, VA, 22040-0747, US

(73) Assignee: LG Chem, Ltd.

(21) Appl. No.: 10/973,387

(22) Filed: Oct. 27, 2004

(30) Foreign Application Priority Data
Oct. 28, 2003 (KR) 2003-75445

(51) Int. Cl. G11B 7/24

(52) U.S. Cl. 369/275.5

(57) ABSTRACT

A cover sheet of a substrate for data storage including a hard coating layer, a plastic containing substrate, and an adhesive layer is provided. Thus, the cover sheet of a uniform thickness can be provided and the substrate for data storage can be provided with scratch resistance and contamination resistance.

### BACKGROUND OF THE INVENTION

This application claims the benefit of Korean Patent Application No. 2003-75445, filed on Oct. 28, 2003, in the Korean Intellectual Property Office, the disclosure of which is incorporated herein in its entirety by reference.

1. Field of the Invention

The present invention relates to a cover sheet of a substrate for data storage, and more particularly, to a cover sheet of an optical disc at the wavelength of blue laser (BD).

2. Description of the Related Art

A disc for data storage originated as a floppy disc of about 1 MB. Evolving to improve the degree of data integration, the floppy disc became the compact disc (CD) of 700-800 MB, and a digital versatile disc of 4-10 GB was developed. Recently, a disc with a storage capacity of 20 GB or more is being developed to provide higher quality of sound and imaging. The improvements of recording density may be achieved by various methods and greatly depends on microminiaturization of the light spots irradiated.

The microminiaturization of the light spots to increase a capacity of integration of data is determined by the wavelength of laser and the numerical aperture of a lens and may be represented by equations 1 and 2.
D=1.22λ/NA Equation 1
F=λ/NA² Equation 2

In the equations 1 and 2, D is a diameter of a spot, λ is a wavelength of laser, NA is the numerical aperture of a lens, and F is focal distance.

As seen from the equation 1, if the wavelength (λ) of laser decreases and the numerical aperture (NA) of a lens increases, the size of a spot decreases. As a result, the pit and tracks of the disc are reduced, and the recording density gets high inversely in proportion to the squared value of the diameter of a spot. Meanwhile, as seen from the equation 2, if the wavelength (λ) of the laser decreases and the numerical aperture (NA) of a lens increases, the focal distance decreases.

In the case of CD, since the focal distance is long, a recording layer is located at a position of 1.1 mm in a disc with a thickness of 1.2 mm. Thus, the CD may be prepared by coating a recording layer on a polycarbonate substrate with a thickness of 1.1 mm, coating a reflection layer and a reflection protecting layer on the recording layer, and attaching a label to the reflection protecting layer. The DVD has a reduced focal distance, and thus a recording layer should be located at a position of 0.6 mm in a disc with a thickness of 1.2 mm. Thus, the DVD may be prepared by coating a recording layer on a polycarbonate substrate with a thickness of 0.6 mm, coating a reflection layer on the recording layer, and coupling the coated polycarbonate substrate with another polycarbonate substrate with a thickness of 0.6 mm through a bonding process. In a CD and DVD, the recording layer may be protected by the polycarbonate substrate with a thickness of 1.1 mm and the polycarbonate substrate with a thickness of 0.6 mm, respectively. In the coating of the reflection protecting layer of the CD and the bonding process of DVD, a spin coating method is used to provide a coating layer with a thickness of several μm to tens μm.

Meanwhile, in the case of an optical disc at the wavelength of blue laser, which is a new generation optical recording media, its focal distance has an increased reduction, and thus a recording layer should be located at a position of 0.1 mm in a disc with a thickness of 1.2 mm. In the case of a single layer optical disc at the wavelength of blue laser, it is proposed that a recording layer is coated on a polycarbonate substrate with a thickness of 1.1 mm, a very thin reflection layer is then coated on the recording layer, and the prepared optical disc is completely covered with a cover sheet having a thickness of 0.1 mm to protect the recording layer. In the case of a double layer optical disc at the wavelength of blue laser, it is proposed that since a spacer layer with a thickness of 0.025 mm is interposed between the two recording layers, the recording layers are protected with a cover sheet with a thickness of 0.075 mm.

In the cover sheet of the optical disc at the wavelength of blue laser, the deviation of thickness of ±0.002 mm is allowed. However, a method of providing the optical disc at the wavelength of blue laser with a cover sheet having deviation of thickness within the above range and a thickness of about 0.1 mm and a material of the cover sheet are not sufficiently developed. Also, an application example of a cover sheet having deviation of thickness within the above range and a thickness of 0.1 mm or 0.075 mm to the optical disc at the wavelength of blue laser has not yet been disclosed.

Japanese Patent Laid-Open Publication No. Hei 11-345433 discloses a UV curable composition used to join two substrates in a method of manufacturing a DVD and a joining process of a DVD, which is not affected by heat from a curing apparatus. The above invention is characterized in that a UV curable resin is applied to a surface of a substrate by spin coating, and the substrate is covered with another substrate, and then two substrates are joined by UV curing the UV curable resin.

U.S. Pat. No. 5,609,990 discloses a UV curable seal coat layer applied to the outer surface of a CD or magneto optic (MO) disc to provide abrasion resistance. A UV curable composition with low viscosity is spin coated on a surface of a CD or MO disc to provide a CD or MO disc with improved abrasion and corrosion resistance.

However, it is very difficult to obtain a coating layer with a thickness of 0.1 mm or 0.075 mm using the spin coating method. In particular, it is technically difficult to form a coating layer with a uniform thickness within a range of deviation of thickness of ±0.002 mm.

Also, since the optical disc at the wavelength of blue laser has a greater degree of integration of data than a conventional CD or DVD and has only a cover sheet with a thickness of about 0.1 mm between a surface of a disc and a recording layer, foreign substances or scratching can easily cause errors in data reproducing. To resolve this problem, it is proposed to place the optical disc at the wavelength of blue laser itself in a cartridge for protection. However, this method increases the producing costs of the optical disc at the wavelength of blue laser and is not advantageous in that its use is inconvenient.

### SUMMARY OF THE INVENTION

The present invention provides a cover sheet of a substrate for data storage including a hard coating layer, a plastic containing substrate, and an adhesive layer, which has a uniform thickness and provides scratch resistance and contamination resistance when applying it to the substrate for data storage.

According to an aspect of the present invention, there is provided a cover sheet of a substrate for data storage including a hard coating layer, a plastic containing substrate, and an adhesive layer.

According to another aspect of the present invention, there is provided a method of preparing a cover sheet of a substrate for data storage, the method including: coating a hard coating material on a surface of a plastic containing substrate and curing the hard coating material; and coating an adhesive composition containing an adhesive on the other surface of said plastic containing substrate.

### BRIEF DESCRIPTION OF THE DRAWINGS

The above and other features and advantages of the present invention will become more apparent by describing in detail exemplary embodiments thereof with reference to the attached drawing in which:

FIG. 1 illustrates the structure of a cover sheet of a substrate for data storage of the present invention.

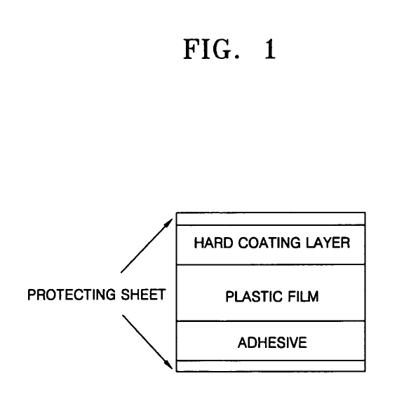

### DETAILED DESCRIPTION OF THE INVENTION

A cover sheet of a substrate for data storage of the present invention should protect a recording layer of the substrate for data storage and satisfy the optical design. Specifically, an optical disc at the wavelength of blue laser should have a cover sheet of a uniform thickness as proposed as a standard in companies that manufacture the optical disc at the wavelength of blue laser, i.e. should have a deviation of thickness within the range of ±0.002 mm.

To satisfy the above requirement, the present invention provides a cover sheet of a substrate for data storage, including a hard coating layer, a plastic containing substrate, and an adhesive layer, in which the hard coating layer, the plastic containing substrate, and the adhesive layer may preferably have a thickness of 0.5-20 μm, 40-90 μm, and 5-40 μm, respectively.

Unlike a prior art forming a cover sheet of a substrate for data storage by a spin coating method, in the present invention, the cover sheet of a substrate for data storage is provided in the form of a sheet so that the thickness of the cover sheet can be easily controlled and the cover sheet with a uniform thickness can be provided. Also, the hard coating layer, which is a constituent of the cover sheet of the present invention, makes up for poor scratch resistance and poor contamination resistance of a plastic to safely protect a substrate for data storage including the cover sheet from scratches and contamination.

The cover sheet of a substrate for data storage of the present invention may be prepared by coating a hard coating material to a thickness of 0.5-20 μm on a surface of a plastic containing substrate with a thickness of 40-90 μm and curing the hard coating material and coating an adhesive composition containing an adhesive to a thickness of 5-40 μm on the other surface of the plastic containing substrate. The prepared cover sheet has a final thickness of 45.5 to 150±2 μm.

The plastic containing substrate acts as a support for the cover sheet of the present invention and should have predetermined properties so as not to impair functions of the cover sheet for data storage. The plastic containing substrate may preferably have the following optical properties: a refractive index of 1.45-1.55, transmittance of laser light of 89% or more at 405 nm, an in-plane birefringence of 1.5×10⁻⁴ or less, and perpendicular plane birefringence of 1.2×10⁻³ or less. The plastic containing substrate may preferably have angular deviations of a reflected beam of 0.6° at a maximum in a direction of a radius and 0.3° at a maximum in a direction of tangent line.

In the present invention, the plastic containing substrate satisfying the above optical properties may preferably be composed of triacetyl cellulose (TAC), polycarbonate (PC), or a mixture thereof. The material of the plastic containing substrate may be selected depending on the type of a substrate for data storage, and, in particular, a thickness of a substrate required in various optical discs at the wavelength of blue laser.

The hard coating layer provides the plastic containing substrate with scratch resistance and contamination resistance and may be formed by coating a hard coating material to a thickness of 0.5-20 μm on a surface of the plastic containing substrate and curing the hard coating material. When the thickness of the hard coating layer is greater than 20 μm, the deviation of the thickness increases. When the thickness of the hard coating layer is less than 0.5 μm, the scratch resistance is significantly reduced. Coating may be performed using a roll coating, doctor blade, cap coating method, and the like, and curing may be performed using an UV curing method.

In the present invention, a UV curable hard coating material described in Korean Patent Application No. 2003-18619, i.e., a UV curable hard coating material including a reactive acrylate oligomer, a polyfunctional acrylate monomer, a long chain fluorine based acrylate, a short chain fluorine based acrylate, an initiator, and the like may be used as the hard coating material. However, the material that may be used as the hard coating material is not particularly restricted as long as it can provide higher scratch resistance and contamination resistance without impairing the functions of a substrate for data storage.

An adhesive layer may preferably be placed on the opposite side of the hard coating layer in the cover sheet to attach the cover sheet of the present invention to a substrate for data storage. The adhesive layer may be formed by coating an adhesive composition containing an adhesive to a thickness of 10-40 μm. When the thickness of the adhesive layer is greater than 40 μm, the deviation of the thickness increases. When the thickness of the adhesive layer is less than 10 μm, it is difficult to provide the adhesion property and the adhesive layer may become loosened due to lowered endurance.

The adhesive used in the present invention may be an acryl based adhesive composition including an acryl based copolymer, a tertiary amine alcohol compound having at least one hydroxy functional group, and a polyfunctional isocyanate based cross-linking agent. However, it is not particularly restricted as long as it does not impair functions of the substrate for data storage.

In the cover sheet of a substrate for data storage prepared as above, i.e., the cover sheet in which the hard coating layer is formed on a surface of the plastic containing substrate and the adhesive layer is formed on the other surface of the plastic containing substrate, protecting sheets may be attached to both surfaces of the cover sheet to protect the hard coating layer and the adhesive layer.

Also, the prepared cover sheet may be tailored so as to have the same size as that of a substrate for data storage. For example, the cover sheet may be tailored so as to have an outer diameter of an optical disc of 120 mm Φ and an inner diameter of 15 mm Φ using a punching tool.

The prepared cover sheet may be applied to the substrate for data storage by depositing the cover sheet such that the adhesive layer contacts the surface of the substrate for data storage right after removing the protecting sheets attached to both surfaces of the cover sheet.

The present invention will now be described in greater detail with reference to the following examples. The following examples are for illustrative purposes and are not intended to limit the scope of the invention.

### EXAMPLES

Physical properties of cover sheets prepared in Examples were determined as follows.

The contamination resistance of the cover sheet was determined by a stationary contact angle to pure water measured using a contact angle meter (available from Kruss).

The scratch resistance of the cover sheet was determined by a jitter value, associated with reading data of an optical disc, measured when abrading 5 times the cover sheet under a load of 250 g on the wheel of CS-10F using Taber abrader.

The transmittance of the cover sheet was measured using DARSA PRO 5000 transmittance measurement apparatus (available from PSI, Korea).

The adhesion property of a hard coating layer was determined according to JIS K5400 by providing a hard coating layer obtained by roll coating and curing with 10 cutting lines at a distance of 1 mm in both transverse and longitudinal directions, respectively, which are in checkered pattern, and strongly attaching a cellophane tape (Cellotape® available from Nichvan Co.) to the hard coating layer, and then securing an end of the tape and forcefully pulling the tape in the direction of 90° to the surface of the hard coating layer. The hard coating layer that was not released was represented as “O” and the hard coating layer that was released was represented as “X”.

The thickness of a film was measured using a micrometer.

### Example 1

LGCOM AU 108GN-H (available from LG Chemicals), which was a UV curable hard coating solution, was roll coated on a surface of a substrate of triacetyl cellulose (TAC) with a thickness of 80 mm and UV of 1 J/cm² was radiated to obtain a hard coating layer with a thickness of 5 μm. Then, an acryl based adhesive composition including an acryl based copolymer and a tertiary amine alcohol compound having a hydroxy functional group, and a polyfunctional isocyanate based cross-linking agent was coated on the other surface of the substrate to a thickness of 15 μm. Protecting sheets were attached to both surfaces of the prepared cover sheet. The prepared cover sheet was tailored using a punching tool so as to have an outer diameter of 120 mm Φ and an inner diameter of 15 mm Φ.

After removing the protecting sheets, the cover sheet was attached to an optical disc at the wavelength of blue laser such that the adhesive layer contacted a ZnS/SiO₂ layer of the optical disc. Physical properties of the cover sheet of the optical disc at the wavelength of blue laser are shown in Table 1.

### Comparative Example 1

The adhesive composition used in Example 1 was coated to a thickness of 15 μm on a surface of a TAC substrate with a thickness of 85 μm and protecting sheets were attached to both surfaces of the prepared cover sheet. The prepared cover sheet was tailored using a punching tool so as to have an outer diameter of 120 mm Φ and an inner diameter of 15 mm Φ.

After removing the protecting sheets, the cover sheet was attached to a HD-DVD ROM disc such that the adhesive layer contacted a metal or a metal oxide layer of the HD-DVD ROM disc. Physical properties of the cover sheet of the HD-DVD ROM disc are shown in Table 1.

### Comparative Example 2

An acrylate based UV curable composition composed of urethane acrylate with a viscosity of 5000 cP, an initiator, and additives was coated on a surface of an optical disc at the wavelength of blue laser by spin coating at 800 rpm for 40 seconds. Physical properties of the prepared cover layer of the optical disc at the wavelength of blue laser are shown in Table 1.

TABLE 1
Physical properties of cover layers of optical discs

| | | Jitter | | | |
|---|---|---|---|---|---|
| | Transmit- | value | Thickness | Contact | |
| | tance | (Tabor | of film, | angle | |
| Property | at 405 nm | test) | deviation | (°) | Adhesion |
| Example 1 | 89% | 8% | 100 ± 1 μm | 98 | ◯ |
| Comparative | 93% | Servo | 100 ± 1 μm | 77 | ◯ |
| Example 1 | | error | | | |
| Comparative | 89% | Servo | 90 ± 20 μm | 66 | ◯ |
| Example 2 | | error | | | |

As seen from Table 1, Example 1 using the cover sheet of the present invention, in the form of a sheet, which includes the hard coating layer, the plastic containing substrate, and the adhesive layer, has a very uniform thickness (±1 μm). Also, Example 1 including the hard coating layer shows a larger contact angle compared to the case not including the hard coating layer, indicating better contamination resistance.

Meanwhile, Comparative Example 1, which has the same cover sheet form but does not include a hard coating layer, has a jitter value of an error state. This indicates that the substrate for data storage was too significantly impaired to read data after the scratch test. Also, a relatively small contact angle indicates low contamination resistance.

Also, in the case of Comparative Example 2 where the UV curable composition was coated using a spin coating method, the deviation of thickness is serious (±20 μm) and poor scratch resistance and contamination resistance are apparent from its jitter value and contact angle.

A cover sheet including a hard coating layer, a plastic containing substrate, and an adhesive layer according to the present invention can be applied to a substrate for data storage, in particular, an optical disc at the wavelength of blue laser to provide a uniform thickness of the cover sheet required for the optical design of an optical disc at the wavelength of blue laser and the hard coating layer can protect a recording layer of data from scratches and contamination. Also, the optical disc at the wavelength of blue laser including the cover sheet can replace a conventional optical disc at the wavelength of blue laser having a cartridge.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A cover sheet of a substrate for data storage comprising a hard coating layer, a plastic containing substrate, and an adhesive layer.

2. The cover sheet of a substrate for data storage of claim 1, wherein the hard coating layer, the plastic containing substrate, and the adhesive layer have a thickness of 0.5-20 μm, 40-90 μm, and 5-40 μm, respectively.

3. The cover sheet of a substrate for data storage of claim 1, wherein a material of the plastic containing substrate is selected from the group consisting of polycarbonate, triacetyl cellulose, and a mixture thereof.

4. The cover sheet of a substrate for data storage of claim 1, wherein protecting sheets are attached to both surfaces of the cover sheet.

5. A substrate for data storage having the cover sheet of any one of claims 1 to 3 attached to a surface thereof.

6. A method of preparing a cover sheet of a substrate for data storage, the method comprising:
coating a hard coating material on a surface of a plastic containing substrate and curing the hard coating material; and
coating an adhesive composition containing an adhesive on the other surface of the plastic containing substrate.

7. The method of claim 6, further comprising attaching protecting sheets to both sides of the prepared cover sheet.

8. The method of claim 7, further comprising tailoring the prepared cover sheet in the form of a substrate for data storage.
